(19) United States
(12) Patent Application Publication
(10) Pub. No.: US 2013/0107369 A1
(43) Pub. Date: May 2, 2013

(54) HEARTH LINER FOR OPTICAL THIN FILM FORMATION

(71) Applicants: KEN SEKI, SAITAMA (JP); TOSHIMASA NISHI, SAITAMA (JP); HIROTO ISHIKAWA, SAITAMA (JP)

(72) Inventors: KEN SEKI, SAITAMA (JP); TOSHIMASA NISHI, SAITAMA (JP); HIROTO ISHIKAWA, SAITAMA (JP)

(73) Assignee: NIHON DEMPA KOGYO CO., LTD., TOKYO (JP)

(21) Appl. No.: 13/454,025

(22) Filed: Apr. 23, 2012

(30) Foreign Application Priority Data
Apr. 28, 2011 (JP) 2011-100421

(51) Int. Cl. B05C 11/00; G02B 5/22

(52) U.S. Cl. CPC B05C 11/00; G02B 5/22
USPC 359/577; 427/162; 428/156; 428/174

(57) ABSTRACT

In a hearth liner wherein an evaporation material is adhered to a substrate to form an optical thin film thereon, the present invention is directed to prevent bumping (splashing) when the evaporation material is irradiated by an electron beam from an electron gun to melt and vaporize thereof. A hearth liner of a vacuum evaporation apparatus wherein the electron beam from the electron gun is irradiated on the evaporation material to form an optical thin film on a substrate, wherein the cross-section shape of an evaporation material storage part of the hearth liner is a shallow semicircular (spherical) shape (bowl shape).

### CROSS-REFERENCE TO RELATED APPLICATION

This application claims the priority benefit of Japan application serial no. 2011-100421, filed on Apr. 28, 2011. The entirety of the above-mentioned patent application is hereby incorporated by reference herein and made a part of this specification.

### BACKGROUND OF THE INVENTION

1. Field of the Invention

The present invention relates to a hearth liner for a vacuum evaporation apparatus using an electron gun in particular to a hearth liner for optical thin film formation wherein a cross-section shape of an evaporation material storage part of the hearth liner is semicircular like a bowl.

2. Description of the Related Art

An optical filter is produced by forming an optical thin film comprising of a metallic thin film and a dielectric thin film on a surface of a substrate material such as quartz crystal or glass.

For example, as shown in FIG. 5, by using a vacuum evaporation apparatus 10, a hearth liner 1 storing an evaporation material is disposed in a recess of a crucible 12 within a vacuum chamber 11 of the vacuum evaporation apparatus 10, a high-voltage current is applied to a filament 13, and an electron beam generated is induced into the hearth liner 1 by magnets 14a and 14b. The evaporation material within the hearth liner 1 is evaporated and vaporized while the hearth liner 1 is indirectly cooled, and the evaporation material is adhered to a surface of a substrate 15 disposed within the vacuum chamber 11 to form a thin film thereon.

In particular, in the case where an electron beam evaporation source (electron gun) that irradiates an electron beam is used as a means for evaporating the evaporation material, as shown in FIG. 6, for example, a hearth liner made of a material with high thermal insulation properties (such as copper) is put inside a copper crucible that is cooled by water-cooling, the hearth liner is filled with an evaporation material, and the evaporation material is heated by irradiating an electron beam to evaporate and vaporize the evaporation material.

By using such a hearth liner, when cleaning grime after evaporation, since the inside (recess) of the crucible is not stained, the vacuum evaporation apparatus can be cleaned by removing only the hearth liner, which is a relatively small part, from the crucible after its use. Therefore, the cleaning of the vacuum evaporation apparatus is extremely easy.

### DESCRIPTION OF THE PRIOR ART

Patent Document 1: Japanese Patent Laid Open Publication No. 2010-255059

### SUMMARY OF THE INVENTION

### Problem to be Solved by the Invention

Conventionally, when forming an optical thin film with a vacuum evaporation apparatus, a mortar-shaped hearth liner made of oxygen-free copper into which an evaporation material has been stored (see FIGS. 7(a) and 7(b)) is loaded into a crucible within the vacuum evaporation apparatus, and an electron beam is irradiated from an electron gun to melt and vaporize the evaporation material and adhere a thin film on the surface of a crystal or glass substrate, thereby forming an optical thin film thereon. As shown in FIGS. 7(a) and 7(b), the mortar-shaped hearth liner 1c of the above conventional example has a mortar-shaped outer peripheral surface 3c and an inner surface 4c, and the inner surface 4c is formed connected to a bottom 2c, such that an evaporation material storage part S having a relatively deep bottom is formed.

If titanium oxide (Ti₃O₅) is used for the evaporation material, the conventional art has a problem as explained below. First, as shown in FIG. 8, hearth liners are placed in the recess of a rotating crucible of a vacuum evaporation apparatus, the evaporation material (titanium oxide) stored in the hearth liners is irradiated by an electron beam from an electron gun that is disposed facing the recesses of the crucible to melt the evaporation material, and the vaporized evaporation material is adhered (deposited) on the surface of a crystal or glass substrate. Therein, since the crucible is cooled to approximately 40° C. by cold water as shown in FIG. 5, the copper hearth liners in which evaporation material has been stored and the evaporation material within the hearth liners are in a pre-melted state. Titanium oxide (Ti₃O₅) and SiO₂ are then alternately and repeatedly supplied while adding evaporation material, the amount of which has decreased due to film formation, to the hearth liners, and thereby an optical thin film consisting of TiO₂ and SiO₂ and having approximately, for example, 40 to 50 layers is formed on the substrate. The hearth liners are used in film formation many times, on the order of several tens of times.

However, since the hearth liners placed inside the crucible are also indirectly cooled by the crucible that is cooled by cold water, the outer peripheral part of the evaporation material in the hearth liners still remains pre-melted state even if its center part melts. Therefore, when melting the evaporation material by irradiating the electron beam, the evaporation material that has not melted falls into the portions of the evaporation material that has melted, and splashing (bumping) can be occurred at this time due to a sudden temperature change of the melted evaporation material. As a result, a powder and liquid of the evaporation material may adhere to the surface of the crystal substrate or the like, and this can lead to cause a defective product.

In addition, if a hearth liner is used repeatedly while adding evaporation material, the evaporation material in the hearth liner repeatedly melts and solidifies. Thus, oxygen escapes from the evaporation material (titanium oxide: Ti₃O₅) that exists at the bottom of the hearth liner, leading to the formation of Ti₂O₃. The melting point of Ti₂O₃ is approximately 200° C. higher than that of Ti₃O₅, thus even if it is irradiated with an electron beam, it does not melt and turns into a powder, and the volume of this powder portion increases. If this powder portion is irradiated by an electron beam, splashing (bumping) can be occurred.

### Means for Solving the Problem

In order to solve the above-described problem, the present invention provides a hearth liner for a vacuum evaporation apparatus in which an electron beam from an electron gun is irradiated on an evaporation material to form an optical thin film on a substrate, wherein the cross-section shape of an evaporation material storage part of the hearth liner is a shallow semicircular shape (bowl shape).

The hearth liner of the present invention is further characterized in that a material that forms the hearth liner has a melting point of 1200° C. or greater than this temperature and a heat transfer coefficient of 350 W/mK or less than the coefficient.

The hearth liner of the present invention is further characterized in that a liner part that stores the evaporation material and a tapered liner part that is fitted into a crucible are integrally formed, a concave part having a concave cross-section shape is formed on a bottom surface of the liner that is fitted into a recess of the crucible, and a contact surface area between the crucible and the bottom surface and the tapered part is reduced so as to decrease a degree of cooling of the hearth liner.

The hearth liner of the present invention is further characterized in that the liner part having the evaporation material storage part and the tapered liner part are split into two parts, and they are integrally combined and inserted into the crucible during its use.

The present invention also relates to an optical filter in which an optical thin film is formed using the hearth liner.

### Effects of the Invention

During use of a hearth liner to form an optical thin film by adhering an evaporation material to a substrate such as an optical filter, the occurrence of bumping (splashing) when irradiating the evaporation material by an electron beam from an electron gun to melt and vaporize thereof can be prevented.

### BRIEF DESCRIPTION OF THE DRAWINGS

FIG. 1 shows Embodiment 1 (semicircular hearth liner) of a hearth liner for optical thin film formation of the present invention, where FIG. 1(a) is a plan view and FIG. 1(b) is a front view.

FIG. 2 shows Embodiment 2 (in which a semicircular hearth liner and a tapered liner part are integrated) of a hearth liner for optical thin film formation of the present invention, where FIG. 2(a) is a plan view and FIG. 2(b) is a cross-section view along with an arrow line II-II in FIG. 2(a).

FIG. 3 is a partial cross-section view of Embodiment 3 (in which a liner that stores an evaporation material and a liner that is inserted into a crucible are split into two and stacked upon each other during its use) of a hearth liner for optical thin film formation of the present invention.

FIG. 4 is a conceptual view illustrating the occurrence of convective flow within a melted evaporation material when the evaporation material is melted using a hearth liner for optical thin film formation of the present invention.

FIG. 5 is a conceptual view illustrating an electron beam vacuum evaporation apparatus used in optical thin film formation.

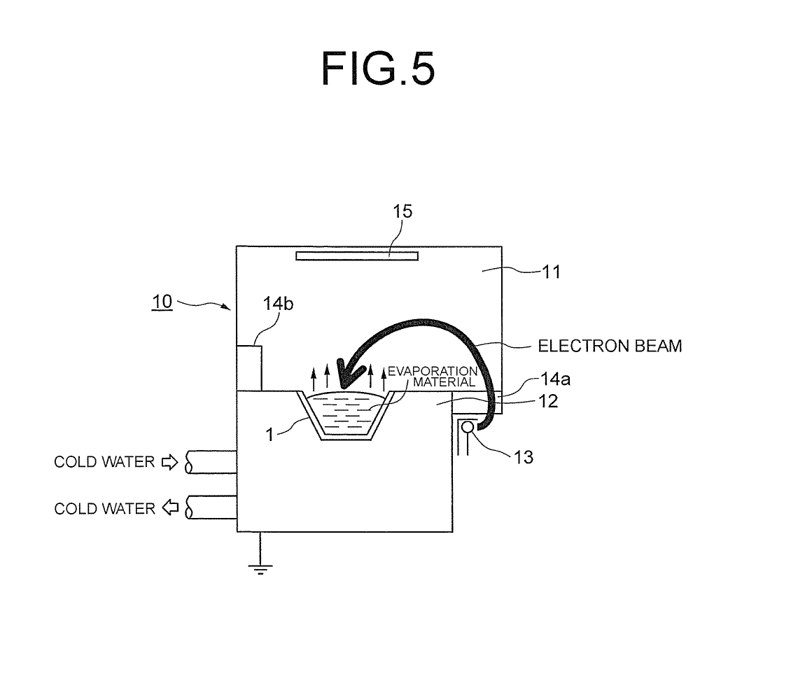

FIG. 6 is a conceptual view illustrating a mortar-shaped crucible inserted into a vacuum evaporation apparatus, a hearth liner filled with evaporation material that is inserted into a recess of the crucible, and formation of an optical thin film by melting the evaporation material by an electron beam, when forming an optical thin film with an electron beam vacuum evaporation apparatus.

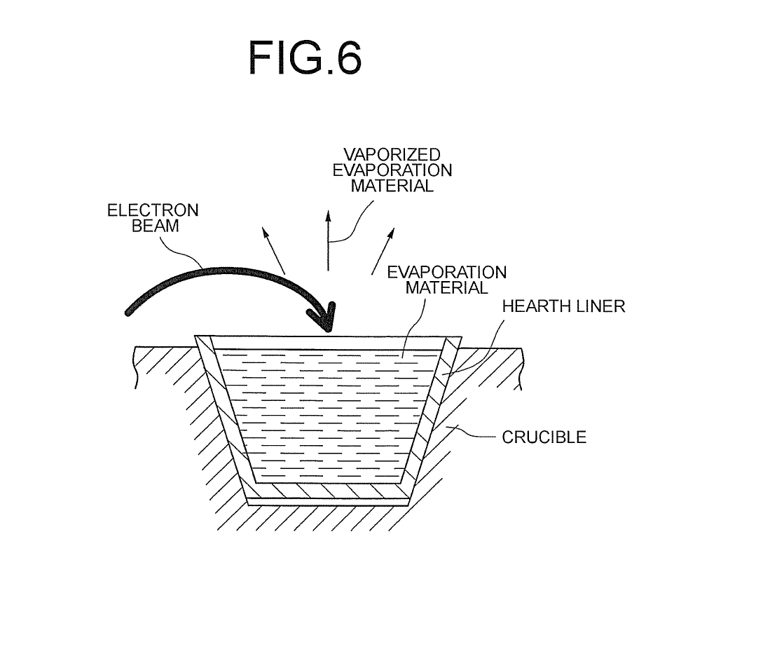

FIG. 7 shows a hearth liner of a conventional example, where FIG. 7(a) is a plan view, and FIG. 7(b) is a front view.

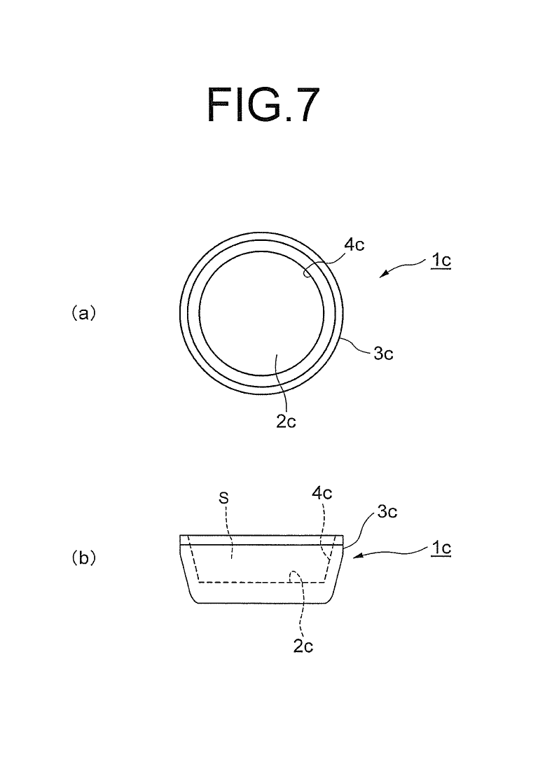

FIG. 8 is a perspective view illustrating a crucible that has recesses for accommodating a plurality of hearth liners and is disposed in a vacuum evaporation apparatus that uses an electron beam.

### MODES FOR CARRYING OUT THE INVENTION

Embodiments of the hearth liner for optical thin film formation of the present invention will be explained below based on the attached drawings.

### Embodiment 1

The hearth liner for optical thin film formation of the present invention is used in the formation of an optical thin film by a vacuum evaporation apparatus using an electron beam on a crystal substrate, an optical glass substrate, phosphate glass, fluorophosphate glass, a lithium niobate substrate, and the like. The optical thin film is formed on the surface of these substrates by alternately coating the surface with TiO₂, which is a high refractive material, while SiO₂, which is a low refractive material, to form, for example, approximately 40 to 50 layers.

The hearth liner of the present invention is used to melt and vaporize a metallic material (Ti₃O₅, Ta₂O₅, etc.), which is a high refractive material. These high refractive materials are black color in the starting material stage, thus oxygen, ions, gas, or the like is introduced into the starting material during film formation to carry out an oxidation reaction and then form a transparent optical thin film (consisting of a TiO₂ oxidized film and SiO₂) on the substrate.

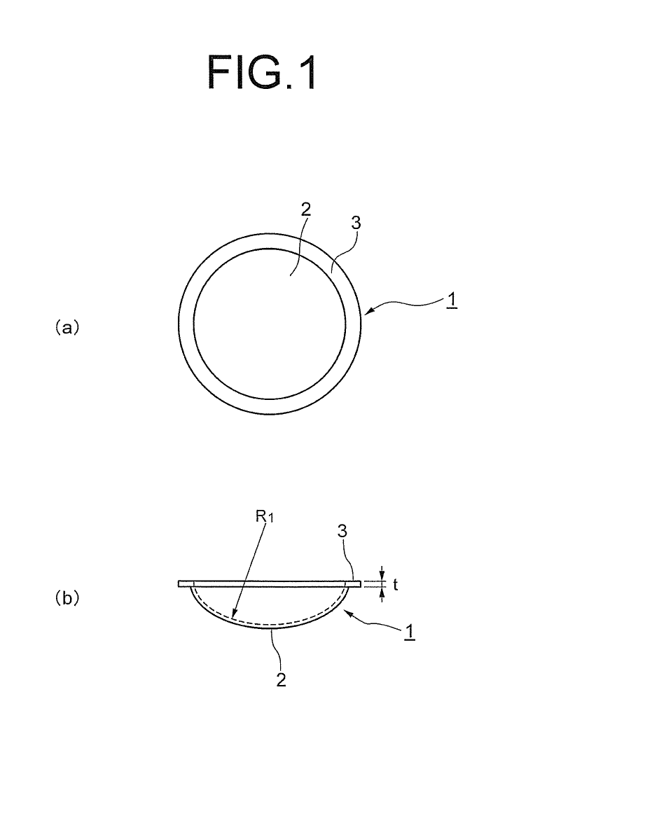

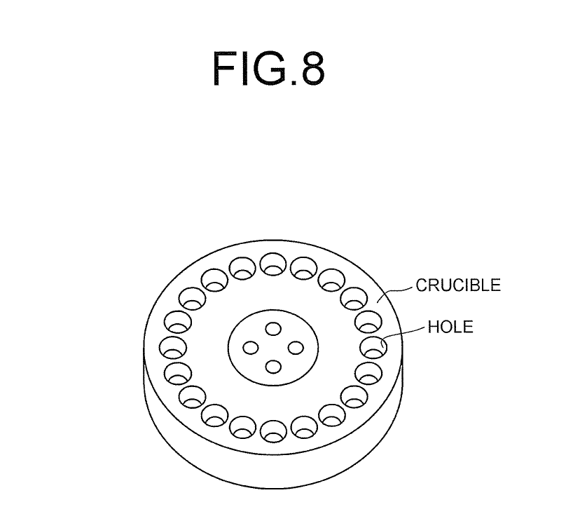

As shown in FIG. 1, in a hearth liner 1 of Embodiment 1 of the present invention, the cross-section shape of an evaporation material storage part 2 is a shallow (for example, a depth of 10.4 mm) semicircular (spherical) concave part (bowl shape) having a radius R₁ (for example, 19 mm). A lip part 3 having a thickness t (for example, 0.3 mm) is formed in a folded manner on the outer edge of the storage part 2. The hearth liner 1 is used by loading it into the recess of a crucible (refer to FIG. 8). Generally, the hearth liner 1 having a diameter of 35, 40, or 45 mm is used.

The hearth liner 1 is generally made of a material that has a melting point of 1200° C. or greater than the temperature and a heat transfer coefficient of 350 W (mK) or less than the coefficient, by, for example, press punching copper (Cu). Depending on the evaporation material, the hearth liner 1 can also be formed from molybdenum (Mo) and tungsten (W).

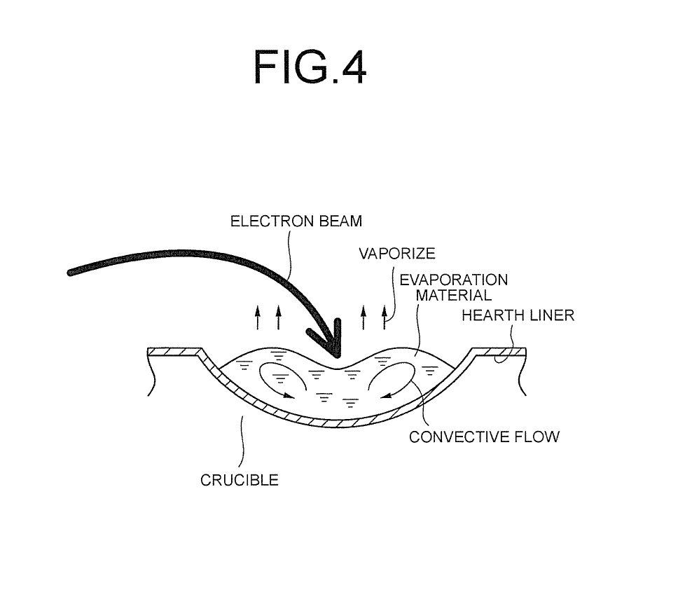

In this way, by forming the evaporation material storage part 2 of the hearth liner 1 such that its cross-section shape is a shallow semicircle (bowl shape), the capacity of the storage part 2 into which evaporation material is stored is lower compared to a conventional hearth liner, thus the amount of evaporation material used each time can be reduced. Further, when irradiating the evaporation material within the storage part 2 with an electron beam to heat and melt it, since the amount of evaporation material is small, and the melting point of the material (for example, copper) constituting the hearth liner 1 is high while the heat transfer thereof is low as described above, the hearth liner 1 can sufficiently withstand high temperatures when the evaporation material is melted. Further, as shown in FIG. 4, since a convective flow occurs within the melted evaporation material so that the entire part of the evaporation material is melted uniformly, oxygen does not escape from the evaporation material (there occurs a formation of Ti₂O₃ from Ti₃O₅), thus bumping (splashing) can be prevented, allowing the stable formation of the optical thin film on the optical substrate.

In Embodiment 1 of the present invention, before storing the evaporation material in the hearth liner 1, black-colored titanium oxide (Ti₃O₅) in a granular state is pre-heated and melted, and then filled into the hearth liner 1. It is then heated and vaporized to oxidize it during film formation so that it turns from black color into a transparent state, thereby forming a transparent optical thin film consisting of TiO₂ and SiO₂ on the surface of the substrate.

Compared to a conventional hearth liner, the hearth liner 1 of the present invention is indirectly cooled via the crucible. Therefore, the evaporation material can be sufficiently melted by the electron beam and the occurrence of bumping (splashing) can be prevented.

Further, if the hearth liner 1 of the present invention is used, since bumping (splashing) does not easily occur during the melting of the evaporation material, the output current of the electron gun can be lowered, by 100 mA for example, compared to a conventional vacuum evaporation apparatus.

### Embodiment 2

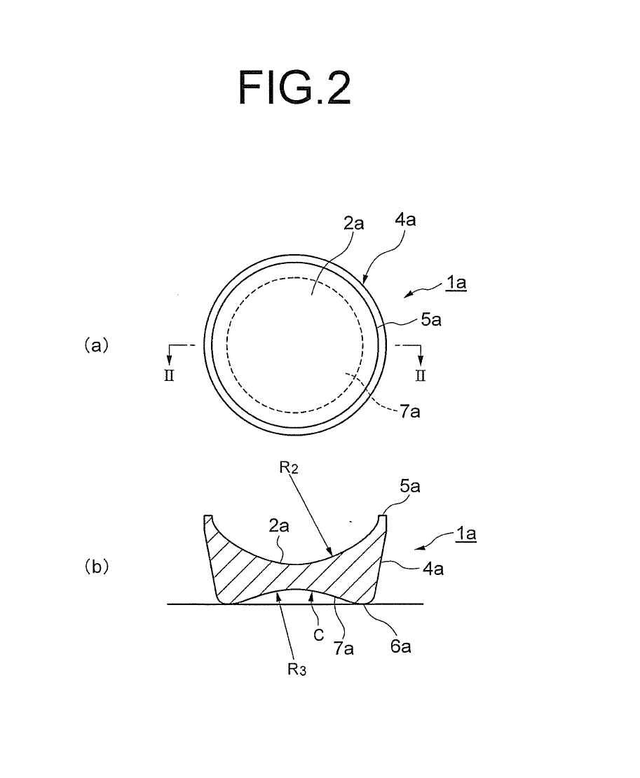

A hearth liner 1a of Embodiment 2 of the present invention is formed by using the same material as that in Embodiment 1. As shown in FIG. 2, a storage part 2a for storing the evaporation material in which the cross-section is a semicircular shape having a radius R₂ and an upper rim 5a, and a tapered part 4a that is fitted into the recess of a crucible (see FIG. 8) are integrally formed using the same material into a solid body. Also, the hearth liner 1a is subjected to casting, grinding, or the like so that a concave part 7a in which the cross-section is a semicircular shape having a radius R₃ is formed on the bottom surface of the hearth liner 1a, and a lower rim 6a (tail) is formed on the outer extension of the concave part 7a.

By constituting the hearth liner 1a as described above, as shown in FIG. 2(b), the area in which the lower rim 6a of the hearth liner 1 contacts with the recess of the crucible is decreased, and a space C is formed between the concave part 7a and the bottom surface of the recess of the crucible. Since the side surface of the tapered part 4a of the hearth liner 1 does not directly contact with the inner surface of the crucible, the hearth liner 1 is not excessively cooled by the crucible. Thus, the evaporation material can be properly heated, melted and vaporized. In addition, since the evaporation material storage part 2a and the tapered part 4a are integrally formed, the hearth liner 1 can be easily exchanged when it has worn out.

### Embodiment 3

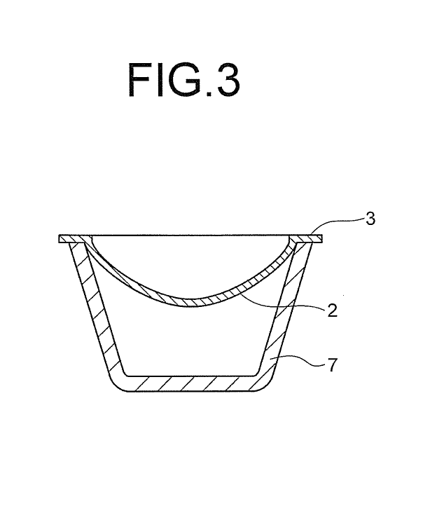

As shown in FIG. 3, a hearth liner 1 of Embodiment 3 of the present invention is split into a liner part 2 for storing the evaporation material which has a semicircular cross-section shape as in above-described Embodiment 1, and a tapered liner part 7 having a bottom which is fitted into the crucible, and both the parts are made of the same material as that in above-described Embodiment 1. During its use, a lip part of the liner 2 is placed onto the liner 7 for inserting the liner 2 that stores the evaporation material into the recess of the crucible to integrate the two liner parts, then they are fitted into the recess of the crucible (see FIG. 8). The evaporation material is subsequently irradiated by the electron beam from an electron gun to heat, melt and vaporize the evaporation material and form an optical thin film on the surface of the substrate.

What is claimed is:

1. A hearth liner for optical thin film formation in a vacuum evaporation apparatus in which an electron beam from an electron gun is irradiated on an evaporation material to form an optical thin film on a substrate, wherein a cross-section shape of an evaporation material storage part of the hearth liner has a shallow semicircular shape.

2. The hearth liner for optical thin film formation according to claim 1, wherein a material that forms the hearth liner has a melting point of 1200° C. or greater than said melting point and a heat transfer coefficient of 350 W/mK or less than said coefficient.

3. The hearth liner for optical thin film formation according to claim 1, wherein a liner part that stores the evaporation material and a tapered liner part that is fitted into a recess of a crucible are integrally formed by the same material, and a concave part is formed on a bottom surface of the liner that is fitted into a recess of the crucible, thereby reducing a contact surface area between the recess of the crucible, the bottom surface and the tapered part.

4. The hearth liner for optical thin film formation according to claim 3, wherein the liner part having the evaporation material storage part and the tapered liner part are split into two parts, and both the liner parts are integrally combined and inserted into the recess of the crucible during its use.

5. An optical filter wherein an optical thin film is formed on a surface thereof by using the hearth liner according to claim 1.

6. An optical filter wherein an optical thin film is formed on a surface thereof by using the hearth liner according to claim 2.

7. An optical filter wherein an optical thin film is formed on a surface thereof by using the hearth liner according to claim 3.

8. An optical filter wherein an optical thin film is formed on a surface thereof by using the hearth liner according to claim 4.

9. A method for forming an optical thin film on a surface by using the hearth liner according to claim 1.

10. A method for forming an optical thin film on a surface by using the hearth liner according to claim 2.

11. A method for forming an optical thin film on a surface by using the hearth liner according to claim 3.

12. A method for forming an optical thin film on a surface by using the hearth liner according to claim 4.
